(19) United States
(12) Patent Application Publication
(10) Pub. No.: US 2016/0034331 A1
(43) Pub. Date: Feb. 4, 2016

(54) MEMORY SYSTEM AND DATA PROTECTION METHOD THEREOF

(71) Applicant: SAMSUNG ELECTRONICS CO., LTD., SUWON-SI (KR)

(72) Inventors: JI MYUNG NA, SUWON-SI (KR); KI HONG KIM, OSAN-SI (KR); KEE MOON CHUN, SEONGNAM-SI (KR)

(21) Appl. No.: 14/681,373

(22) Filed: Apr. 8, 2015

(30) Foreign Application Priority Data
Jul. 29, 2014 (KR) 10-2014-0096740

(51) Int. Cl. G06F 11/07; G06F 21/55

(52) U.S. Cl. CPC G06F 11/079; G06F 11/0727; G06F 11/073; G06F 11/0751; G06F 21/554

(57) ABSTRACT

A memory system includes an abnormality detecting block including a plurality of abnormality detectors to detect whether an abnormal condition has occurred during a normal operation due to an external attack. An abnormality processing block is configured to process the abnormal condition in hardware, and a central processing unit is configured to execute a first process to detect whether the abnormal condition has occurred during the normal operation and to execute a second process to process the abnormal condition in software. A monitoring unit is configured to monitor an operation of the second process and to determine whether an error has occurred in the second process based on a monitoring result.

### CROSS-REFERENCE TO RELATED APPLICATIONS

This application claims priority under 35 U.S.C. §119(a) from Korean Patent Application No. 10-2014-0096740 filed on Jul. 29, 2014, the disclosure of which is hereby incorporated by reference in its entirety.

### BACKGROUND

Embodiments of the inventive concept relate to a memory system and a data protection method thereof, and more particularly, to a memory system for protecting data from external attacks and a method thereof.

Secure devices such as smart cards requiring security have hardware or software that can detect and process external attacks to protect data stored in a core chip. At this time, when an external attack on a secure device is processed in software, a process corresponding to a type of the attack is performed to protect the secure device.

However, other attacks may be made on the secure device even while the attack on the secure device is being processed in software. At this time, the secure device cannot be protected. Therefore, when it is determined that an abnormal process is performed during an operation by software, an approach for handling this is desired.

### SUMMARY

Some embodiments of the inventive concept provide a memory system for guaranteeing the reliability of a secure device by protecting data from external attacks and a method thereof.

According to some embodiments of the inventive concept, there is provided a memory system including an abnormality detecting block including a plurality of abnormality detectors to detect whether an abnormal condition has occurred during a normal operation due to an external attack, an abnormality processing block configured to process the abnormal condition in hardware, a central processing unit configured to execute a first code program or process to detect whether the abnormal condition has occurred during the normal operation and to execute a second code program or process to process the abnormal condition in software, and a monitoring unit configured to monitor an operation of the second code program and to determine whether an error has occurred in the second code program based on a monitoring result.

The second code program may generate an interrupt with respect to the normal operation, define a type of the external attack, and perform an additional process on data, which corresponds to a region on which the external attack is made, or neighboring data based on the type of the external attack.

When it is determined that an error has occurred in the second code program, the monitoring unit may output detection information corresponding to a determination result to the abnormality processing block.

The processing of the abnormal condition in hardware may be an operation in which the memory system enters a sleep mode or an operation of removing data corresponding to a region on which the external attack is made.

The memory system may further include a random number generator configured to generate different random numbers and output the random numbers to the monitoring unit. The monitoring unit may monitor an operation of the second code program based on a check value varying with the random numbers.

The monitoring unit may monitor any one of the normal operation and an operation of the first code program and determine whether an error has occurred in any one of the normal operation and the first code program.

According to other embodiments of the inventive concept, there is provided a method of protecting data in a memory system which includes a monitoring unit configured to monitor an operation of a code program or system process. The method includes: the monitoring unit generating a random access key value and a random check value based on a random number output from a random number generator; the monitoring unit transmitting the random access key value and the random check value to the code program when an access signal is received from the code program within a predetermined period of time; the code program calculating a total check value and a total check time based on a predetermined real check value and the random check value and transmitting the total check value and the total check time to the monitoring unit; and the monitoring unit determining whether an operation corresponding to the total check value is performed by the code program within the total check time.

The monitoring unit may determine that an error has occurred in the code program when the access signal is not received within the predetermined period of time or when the operation corresponding to the total check value is not performed within the total check time.

The real check value may be the number of times a real operation is performed by the code program and the random check value is the number of times a virtual operation is performed by the code program.

The total check time may include a real operation time while the real operation is performed and a virtual operation time while the virtual operation is performed. The virtual operation time may be calculated based on a real check time predetermined for the real operation time.

The method may further include, before determining whether the operation corresponding to the total check value is performed, determining whether an index value from the code program is the same as a target value preset in the monitoring unit each time when the real operation and the virtual operation are completed.

The target value and the index value may increase with a predetermined regularity.

The determining of whether the index value is the same as the target value may include receiving a current index value calculated based on a previous index value after increasing a count value and determining whether the index value is the same as the target value based on a result of comparing a target value corresponding to the increased count value with the current index value.

The method may further include, after the determining of whether the index value is the same as the target value, determining whether the total check time has been reached and determining whether the increased count value is the same as the total check value when it is determined that the total check time has been reached.

The monitoring unit may enter a sleep mode when an end signal and the random access key value are received from the code program after it is determined that the increased count value is the same as the total check value.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a block diagram of a memory system including a monitoring unit according to some embodiments of the inventive concept;

FIG. 2 is a schematic flowchart of a method of protecting data in a memory system according to some embodiments of the inventive concept; and

FIGS. 3A and 3B are detailed flowcharts of a method of protecting data in a memory system according to other embodiments of the inventive concept.

FIG. 4 is a block diagram of an electronic system according to some embodiments of the inventive concept.

### DETAILED DESCRIPTION OF THE EMBODIMENTS

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

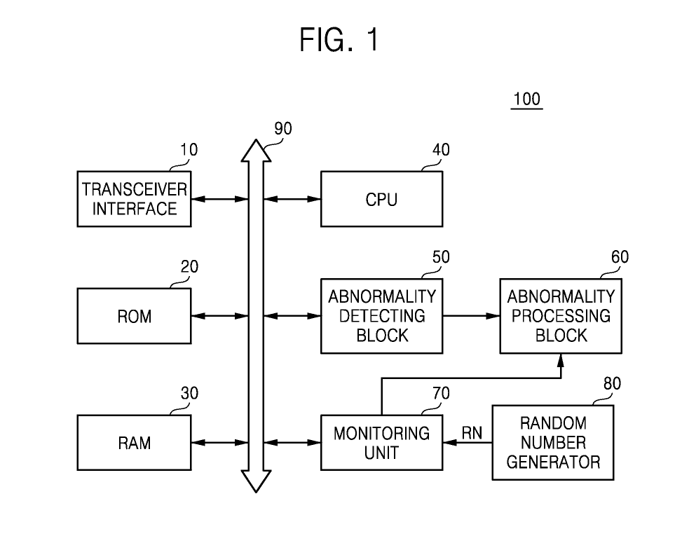

FIG. 1 is a block diagram of a memory system 100 including a monitoring unit 70 according to some embodiments of the inventive concept. The memory system 100 may be implemented as a memory card or a smart card, for example. The memory system 100 includes a transceiver interface 10, a read-only memory (ROM) 20, a random access memory (RAM) 30, a central processing unit (CPU) 40, an abnormality detecting block 50, an abnormality processing block 60, the monitoring unit 70, and a random number generator 80. The elements 10 through 80 may communicate with one another through a bus 90.

The transceiver interface 10 transmits data, addresses, and commands between the memory system 100 and an external device (not shown). The ROM 20 stores code data for interfacing between the CPU 40 and its external device. The ROM 20 may also store predetermined code programs implemented in software to detect or process external attacks on the memory system 100.

The RAM 30 may be used an operation memory of the CPU 40 and may be formed with dynamic RAM (DRAM) or static RAM (SRAM), for example. The RAM 30 may function as a buffer memory and may temporarily store data occurring during a processing operation.

The CPU 40 controls the overall operation of the memory system 100. The CPU 40 may also execute the predetermined code programs stored in the ROM 20.

The abnormality detecting block 50 may detect an abnormal condition occurring due to an external attack that may be made on the memory system 100 during a normal operation and may output detection information. The abnormality detecting block 50 may include a plurality of abnormality detectors each of which may detect a different abnormal condition according to a type of an external attack.

The abnormality processing block 60 may process an abnormal condition in hardware or software based on criteria predetermined by a user to enable an abnormal condition to be processed according to a type of an external attack or importance of data corresponding to an area on which the external attack is made. At this time, processing in hardware may be an operation in which the memory system 100 enters a sleep mode or an operation of removing the data corresponding to the area on which the external attack is made. Processing in software may be an operation of processing the abnormal condition based on a predetermined algorithm depending on the type of the external attack. For instance, it may be an operation of performing an additional process on the data, which corresponds to the area on which the external attack is made, or neighboring data.

The monitoring unit 70 may monitor the operation of a predetermined code program and determine whether an error has occurred in the predetermined code program based on the monitoring result. When determining that an error has occurred in the predetermined code program, the monitoring unit 70 may determine that an abnormal condition has occurred due to an external attack and may output detection information corresponding to the determination result to the abnormality processing block 60.

The random number generator 80 may generate a random number RN using a function having an external environment as a variable or a function complying with certain rules and may output the random number RN to the monitoring unit 70. In other words, the monitoring unit 70 may monitor a predetermined code program based on a check value varying with the random number RN.

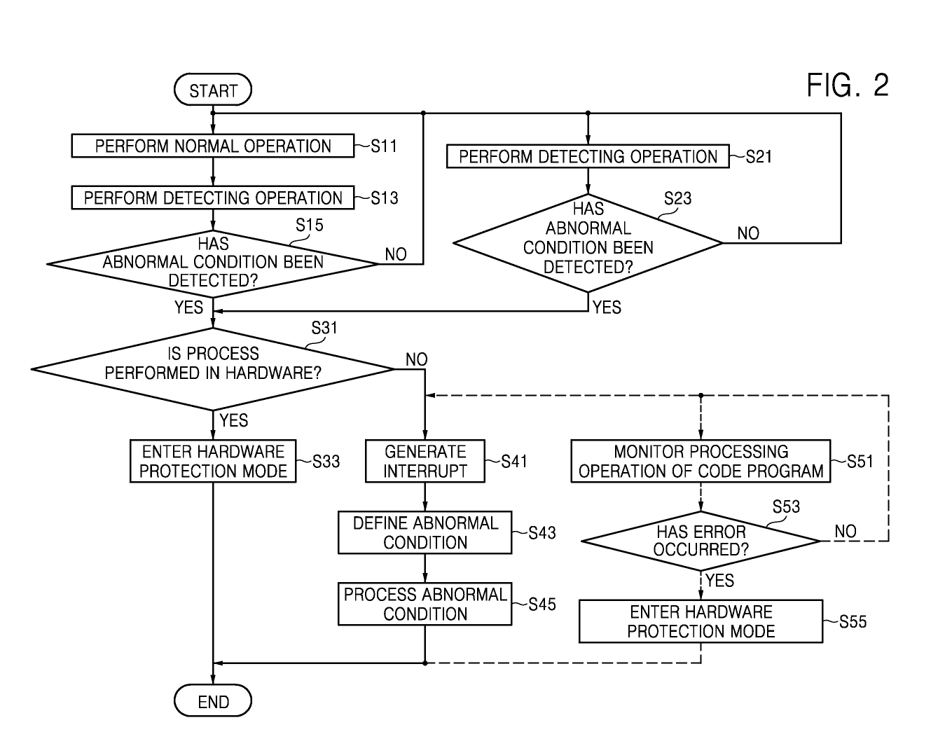

FIG. 2 is a schematic flowchart of a method of protecting data in the memory system 100 according to some embodiments of the inventive concept. Referring to FIGS. 1 and 2, the memory system 100 operates normally in operation S11 and a first code program executed by the CPU 40 performs an operation of detecting an abnormal condition caused by an external attack on the memory system 100 operating normally in operation S13.

The first code program determines whether an abnormal condition has been detected in operation S15 and may continue the detecting operation when it is determined that no abnormal condition has been detected. However, when it is determined that an abnormal condition has been detected, the first code program may output detection information to the abnormality processing block 60.

Meanwhile, the abnormality detecting block 50 performs an operation of detecting whether an abnormal condition has occurred due to an external attack on the memory system 100 operating normally in operation S21 and determines whether an abnormal condition has been detected in operation S23. When it is determined that an abnormal condition has not been detected, the abnormality detecting block 50 continues the detecting operation. When it is determined that an abnormal condition has been detected, the abnormality detecting block 50 may output detection information to the abnormality processing block 60. In other words, when the memory system 100 operates normally, occurrence of an abnormal condition may be detected using the first code program and the abnormality detecting block 50.

The abnormality processing block 60 determines whether the detected abnormal condition will be processed in hardware or software based on criteria predetermined by a user in operation S31. When it is determined that the abnormal condition will be processed in hardware based on the predetermined criteria, the abnormality processing block 60 enters a hardware protection mode in operation S33. In other words, the abnormality processing block 60 may process the abnormal condition in hardware.

However, when it is determined that the abnormal condition will be processed in software in operation S31, a second code program executed by the CPU 40 may generate an interrupt with respect to the normal operation of the memory system 100 in operation S41. The second code program defines the abnormal condition based on a type of an external attack in operation S43 and processes the abnormal condition using a predetermined procedure or algorithm depending on the type of the external attack in operation S45.

At this time, the monitoring unit 70 may monitor the operation of the second code program. In detail, the monitoring unit 70 may monitor the abnormality processing operation of the second code program in operation S51 and determine whether an error has occurred in the second code program in operation S53.

When it is determined that the second code program operates properly in operation S53, the monitoring unit 70 may continue the monitoring operation. However, when it is determined that an error has occurred in the second code program, the monitoring unit 70 determines that an abnormal condition has occurred and may output detection information to the abnormality processing block 60. The abnormality processing block 60 enters the hardware protection mode in operation S55.

A procedure in which the monitoring unit 70 monitors the operation of the second code program processing an abnormal condition has been described in the embodiments illustrated in FIG. 2, but the inventive concept is not restricted to the current embodiments. The monitoring unit 70 may monitor the normal operation of the memory system 100 or the operation of the first code program in other embodiments.

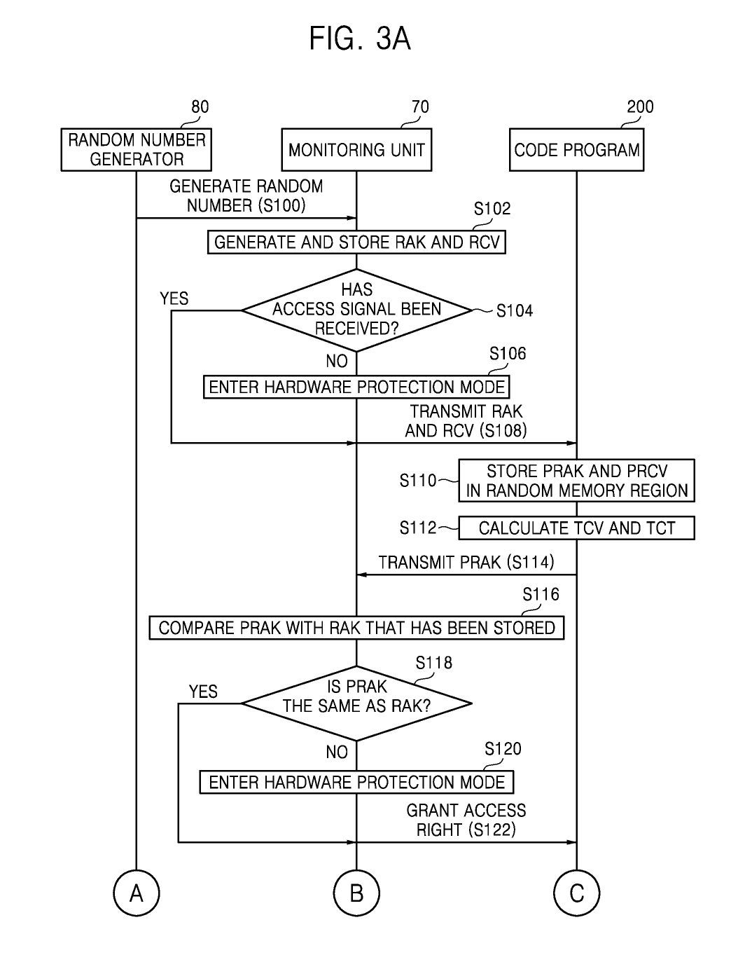

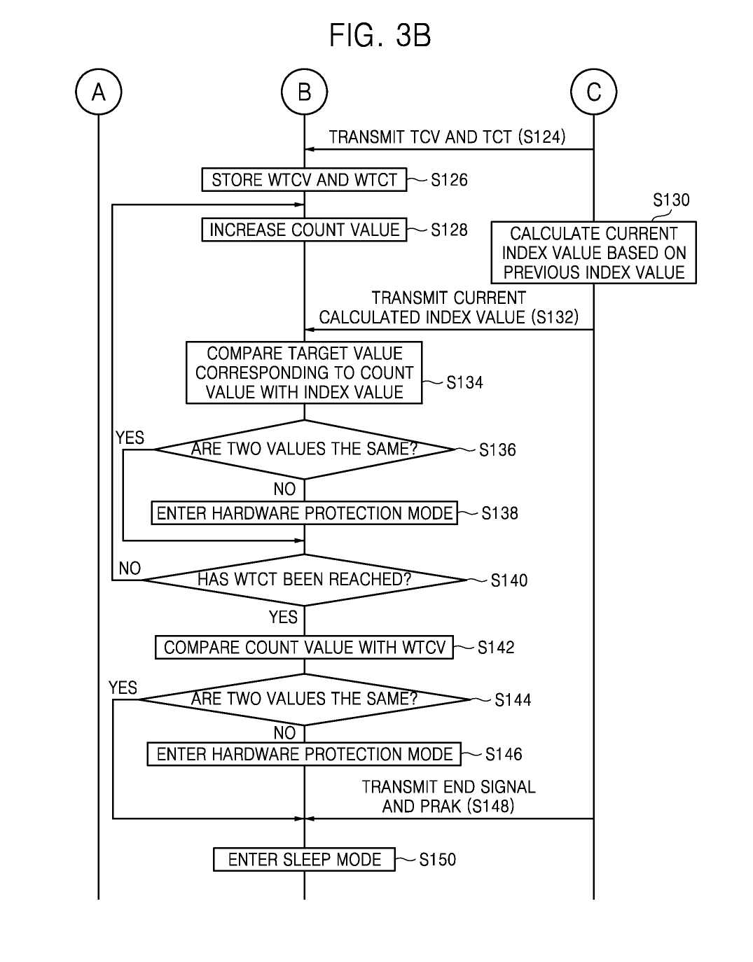

FIGS. 3A and 3B are detailed flowcharts of a method of protecting data in the memory system 100 according to other embodiments of the inventive concept. A code program 200 may be the first or second code program described with reference to FIG. 2 above. Referring to FIGS. 3A and 3B, the random number generator 80 generates and outputs the random number RN to the monitoring unit 70 in operation S100. The monitoring unit 70 generates a random access key value RAK and a random check value RCV based on the random number RN and stores the random access key value RAK and the random check value RCV in operation S102.

The monitoring unit 70 determines whether an access signal is received from the code program 200 within a predetermined period of time in operation S104. When no access signal is received within the predetermined period of time, the monitoring unit 70 enters a hardware protection mode in operation S106. In other words, the monitoring unit 70 determines that an abnormal condition has occurred in the code program 200 due to an external attack and outputs detection information corresponding to the abnormal condition to the abnormality processing block 60. The abnormality processing block 60 processes the abnormal condition in hardware.

When it is determined that an access signal has been received within the predetermined period of time in operation S104, the monitoring unit 70 transmits the random access key value RAK and the random check value RCV to the code program 200 in operation S108. The code program 200 stores the values RAK and RCV as a random access key value PRAK and a random check value PRCV, respectively, in a random memory region in operation S110. At this time, the random memory region may be a region corresponding to a random address in a storage space such as the RAM 30 or the CPU 40 in the memory system 100. In other words, values are stored in the random memory region to prevent the values from being easily accessed by an external attack.

The code program 200 may calculate a total check value TCV and a total check time TCT based on a predetermined real check value and the random check value PRCV in operation S112. At this time, the real check value may be the number of times a real operation is performed by the code program 200 and the random check value PRCV may be the number of times virtual operation is performed by the code program 200. In other words, the code program 200 may calculate the total check value TCV by adding the real check value and the random check value PRCV.

In addition, the code program 200 may calculate a virtual operation time while the virtual operation is being performed based on a real check time predetermined for a real operation time while the real operation is being performed. The total check time TCT may be calculated by adding the real operation time and the virtual operation time.

For instance, when the random check value RCV generated based on the random number RN is 2 in a state where the code program 200 is configured to perform the real operation four times, the code program 200 performs an operation six times in total. At this time, the code program 200 calculates a check time for two virtual operations based on a check time predetermined for four real operations and calculates the total check time TCT for a total of six operations.

After calculating the total check value TCV and the total check time TCT, the code program 200 transmits the random access key value PRAK to the monitoring unit 70 in operation S114. The monitoring unit 70 compares the received random access key value PRAK with the stored random access key value RAK in operation S116 and determines whether the random access key value PRAK is the same as the random access key value RAK in operation S118.

When it is determined that the values PRAK and RAK are not the same in operation S118, the monitoring unit 70 enters the hardware protection mode in operation S120. When it is determined that the values PRAK and RAK are the same, the monitoring unit 70 grants an access right to the code program 200 in operation S122.

Thereafter, the code program 200 transmits the total check value TCV and the total check time TCT to the monitoring unit 70 in operation S124. The monitoring unit 70 stores the value TCV and the time TCT as a total check value WTCV and a total check time WTCT, respectively, in operation S126.

The monitoring unit 70 increases a count value in operation S128. The code program 200 calculates a current index value based on a previous index value in operation S130 and transmits the calculated index value to the monitoring unit 70 in operation S132.

The monitoring unit 70 compares the index value with a target value stored in advance to correspond to the count value in operation S134 and determines whether the index value is the same as the target value in operation S136. At this time, the index value may be a value output from the code program 200 each time when an entire operation by the code program 200 is completed. The target value and the index value may increase with a predetermined regularity.

When it is determined that the index value is not the same as the target value in operation S136, the monitoring unit 70 enters the hardware protection mode in operation S138. When it is determined that the index value is the same as the target value, the monitoring unit 70 determines whether the total check time WTCT has been reached in operation S140. For this operation, the monitoring unit 70 may include a timer (not shown).

When the total check time WTCT has not been reached, the monitoring unit 70 and the code program 200 may repeat operations S128 through S136. However, when the total check time WTCT has been reached, the monitoring unit 70 determines whether the increased count value is the same as the total check value WTCV in operation S144.

When it is determined that the increased count value is not the same as the total check value WTCV in operation S144, the monitoring unit 70 enters the hardware protection mode in operation S146. However, when it is determined that the increased count value is the same as the total check value WTCV and an end signal and the random access key value PRAK are received from the code program 200, the monitoring unit 70 enters a sleep mode in operation S150.

Although the method ends after operations S100 through S146 are completed in a single procedure in the embodiments illustrated in FIGS. 3A and 3B, the inventive concept is not restricted to the current embodiments. The procedure may be performed more than once according to a user's configuration or the properties of the memory system 100.

In other words, the monitoring unit 70 generates the random check value RCV in response to an operation of the random number generator 80 outputting the random number RN, and therefore, the sequence, number and time of operations performed by the code program 200 may be different at every run of the method. Consequently, operations are irregularly performed in software running through interface with the monitoring unit 70, and therefore, the memory system 100 protects data from external attacks, thereby improving or guaranteeing the reliability of a secure device.

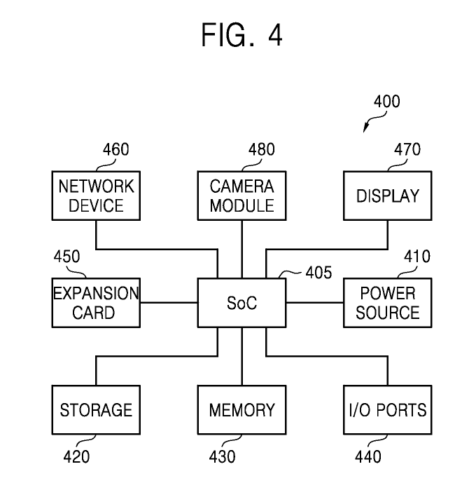

FIG. 4 is a block diagram of an electronic system 400 according to some embodiments of the inventive concept. Referring to FIG. 4, the electronic system 400 may be implemented as a PC, a data server, or a portable device. The portable device may be a laptop computer, a cellular phone, a smart phone, a tablet personal computer (PC), a personal digital assistant (PDA), an enterprise digital assistant (EDA), a digital still camera, a digital video camera, a portable multimedia player (PMP), portable navigation device (PND), a handheld game console, or an e(electronic)-book device.

The electronic system 400 includes a system on chip (SoC) 405, a power source 410, a storage 420, a memory 430, I/O ports 440, an expansion card 450, a network device 460, and a display 470. According to some embodiments, the electronic system 400 may further include a camera module 480.

The SoC 405 may control the operation of at least one of the elements 410 through 480.

The power source 410 may supply an operating voltage to at least one of the elements 405, and 420 through 480. The storage 420 may be implemented by a hard disk drive (HDD) or a solid state drive (SSD).

The memory 430 may be implemented by a volatile or non-volatile memory. A memory controller (not shown) that controls a data access operation, e.g., a read operation, a write operation (or a program operation), or an erase operation, on the memory 430 may be integrated into or embedded in the SoC 405. Alternatively, the memory controller may be provided between the SoC 405 and the memory 430.

The storage 420 may store programs or data. The storage 420 may be implemented by the memory system 100 illustrated in FIG. 1.

The memory 430 may store programs or data. When the memory 430 may be implemented by the non-volatile memory, the memory 430 may be implemented by the memory system 100 illustrated in FIG. 1.

The I/O ports 440 are ports that receive data transmitted to the electronic system 400 or transmit data from the electronic system 400 to an external device. For instance, the I/O ports 440 may include a port connecting with a pointing device such as a computer mouse, a port connecting with a printer, and a port connecting with a USB drive.

The expansion card 450 may be implemented as a secure digital (SD) card or a multimedia card (MMC). The expansion card 450 may be a subscriber identity module (SIM) card or a universal SIM (USIM) card.

The network device 460 enables the electronic system 400 to be connected with a wired or wireless network. The display 470 displays data output from the storage 420, the memory 430, the I/O ports 440, the expansion card 450, or the network device 460.

The camera module 480 converts optical images into digital images. Accordingly, the digital images output from the camera module 480 may be stored in the storage 420, the memory 430, or the expansion card 450. Also, the digital images output from the camera module 480 may be displayed through the display 470.

As described above, according to some embodiments of the inventive concept, a memory system protects data from external attacks, thereby guaranteeing the reliability of a secure device.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A memory system comprising:
an abnormality detecting block comprising a plurality of abnormality detectors to detect whether an abnormal condition has occurred during a normal operation of the memory system due to an external attack;
an abnormality processing block configured to process the abnormal condition in hardware;
a central processing unit configured to execute a first process to detect whether the abnormal condition has occurred during the normal operation and to execute a second process to process the abnormal condition in software; and
a monitoring unit configured to monitor an operation of the second process and to determine whether an error has occurred in the second process based on a monitoring result.

2. The memory system of claim 1, wherein the second process generates an interrupt with respect to the normal operation, defines a type of the external attack, and performs an additional process on data, which corresponds to a region on which the external attack is made, or neighboring data, based on the type of the external attack.

3. The memory system of claim 1, wherein when it is determined that an error has occurred in the second process, the monitoring unit outputs detection information corresponding to a determination result to the abnormality processing block.

4. The memory system of claim 1, wherein processing the abnormal condition in hardware comprises at least one of an operation in which the memory system enters a sleep mode and an operation of removing data corresponding to a region on which the external attack is made.

5. The memory system of claim 1, further comprising a random number generator configured to generate different random numbers and output the random numbers to the monitoring unit; wherein the monitoring unit is configured to monitor the second process based on a check value varying with the random numbers.

6. The memory system of claim 1, wherein the monitoring unit is configured to monitor at least one of the normal operation and the first process and determine whether an error has occurred therein.

7. A method of protecting data in a memory system which includes a monitoring unit configured to monitor an operation of a system process, the method comprising:
the monitoring unit generating a random access key value and a random check value based on a random number output from a random number generator;
the monitoring unit transmitting the random access key value and the random check value to the system process when an access signal is received from the system process within a predetermined period of time;
the system process calculating a total check value and a total check time based on a predetermined real check value and the random check value and transmitting the total check value and the total check time to the monitoring unit; and
the monitoring unit determining whether an operation corresponding to the total check value is performed by the system process within the total check time.

8. The method of claim 7, wherein the monitoring unit determines that an error has occurred in the system process when the access signal is not received within the predetermined period of time or when the operation corresponding to the total check value is not performed within the total check time.

9. The method of claim 7, wherein the real check value is the number of times a real operation is performed by the system process and the random check value is the number of times a virtual operation is performed by the system process.

10. The method of claim 9, wherein the total check time comprises a real operation time while the real operation is performed and a virtual operation time while the virtual operation is performed, and the virtual operation time is calculated based on a real check time predetermined for the real operation time.

11. The method of claim 9, further comprising, before determining whether the operation corresponding to the total check value is performed, determining whether an index value from the system process is the same as a target value preset in the monitoring unit each time when the real operation and the virtual operation are completed.

12. The method of claim 11, wherein the target value and the index value increase with a predetermined regularity.

13. The method of claim 11, wherein determining whether the index value is the same as the target value comprises:
receiving a current index value calculated based on a previous index value after increasing a count value; and
determining whether the index value is the same as the target value based on a result of comparing a target value corresponding to the increased count value with the current index value.

14. The method of claim 11, further comprising, after the determining whether the index value is the same as the target value:
determining whether the total check time has been reached; and
determining whether the increased count value is the same as the total check value when it is determined that the total check time has been reached.

15. The method of claim 14, wherein the monitoring unit enters a sleep mode when an end signal and the random access key value are received from the system process after it is determined that the increased count value is the same as the total check value.

16. A method of protecting data in a memory system which includes a monitoring unit, the method comprising:
detecting whether an abnormal condition has occurred during a normal operation of the memory system due to an external attack;
processing the abnormal condition in hardware;
executing a first process to detect whether the abnormal condition has occurred during the normal operation, and executing a second process to process the abnormal condition in software; and
the monitoring unit monitoring an operation of the second process to determine whether an error has occurred in the second process based on a monitoring result.

17. The method of claim 16, wherein the second process generates an interrupt with respect to the normal operation, defines a type of the external attack, and performs an additional process on data, which corresponds to a region on which the external attack is made, or neighboring data, based on the type of the external attack.

18. The method of claim 16, wherein when it is determined that an error has occurred in the second process, the monitoring unit outputs detection information corresponding to a determination result.

19. The method of claim 16, wherein processing the abnormal condition in hardware comprises at least one of an operation in which the memory system enters a sleep mode and an operation of removing data corresponding to a region on which the external attack is made.

20. The method of claim 16, further comprising generating different random numbers and outputting the random numbers to the monitoring unit; wherein the monitoring unit monitors the second process based on a check value varying with the random numbers.
